(19) United States
(12) Patent Application Publication
(10) Pub. No.: US 2026/0019872 A1
(43) Pub. Date: Jan. 15, 2026

(54) METHOD AND DEVICE FOR COMBINED TRANSMISSION OF VOICE PACKETS IN NON-TERRESTRIAL NETWORK

(71) Applicants: HYUNDAI MOTOR COMPANY, Seoul (KR); KIA CORPORATION, Seoul (KR)

(72) Inventor: Young Kil Suh, Hwaseong-si, Gyeonggi-do (KR)

(73) Assignees: HYUNDAI MOTOR COMPANY, Seoul (KR); KIA CORPORATION, Seoul (KR)

(21) Appl. No.: 18/995,105

(22) PCT Filed: Sep. 27, 2023
(86) PCT No.: PCT/KR2023/014964

§ 371 Date: Jan. 15, 2025

(30) Foreign Application Priority Data
Sep. 30, 2022 (KR) 10-2022-0125650

(51) Int. Cl. H04W 28/06; H04L 1/00; H04W 84/06

(52) U.S. Cl. CPC H04W 28/065; H04L 1/0061; H04W 84/06

(57) ABSTRACT

A method and a device for combined transmission of voice packets in non-terrestrial network are disclosed. A method of a UE comprises the steps of: receiving aggregation configuration information for a packet aggregation operation from a base station; generating a first combined packet comprising multiple packets on the basis of the aggregation configuration information; and transmitting the first combined packet to the base station.

### TECHNICAL FIELD

The present disclosure relates to an uplink communication technique in a non-terrestrial network, and more particularly, to a technique for aggregated transmission of voice packets.

### BACKGROUND ART

A communication network (e.g. 5G communication network, 6G communication network, etc.) to provide enhanced communication services compared to the existing communication network (e.g. long term evolution (LTE), LTE-Advanced (LTA-A), etc.) is being developed. The 5G communication network (e.g. new radio (NR) communication network) can support not only a frequency band of 6 GHz or below, but also a frequency band of 6 GHz or above. That is, the 5G communication network can support a frequency range (FR1) band and/or FR2 band. The 5G communication network can support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and the like.

The 6G communication network can support a variety of communication services and scenarios compared to the 5G communication network. The 6G communication networks can meet the requirements of hyper-performance, hyper-bandwidth, hyper-space, hyper-precision, hyper-intelligence, and/or hyper-reliability. The 6G communication networks can support various and wide frequency bands and can be applied to various usage scenarios (e.g. terrestrial communication, non-terrestrial communication, sidelink communication, and the like).

The communication network (e.g. 5G communication network, 6G communication network, etc.) may provide communication services to terminals located on the ground. Recently, the demand for communication services for not only terrestrial but also non-terrestrial airplanes, drones, and satellites has been increasing, and for this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g. airplane, drone, or the like) may be performed based on 5G communication technology, 6G communication technology, and/or the like. In the NTN, the satellite may perform functions of a base station in a communication network (e.g. 5G communication network, 6G communication network, and/or the like).

Meanwhile, a non-terrestrial network can support voice call services. A terminal can transmit voice packets via Physical Uplink Shared Channel (PUSCH). The voice packets can be transmitted at a preconfigured interval (e.g. 20 ms). A voice packet may include a header, payload, and Cyclic Redundancy Check (CRC) field. Since the size of header in the voice packet is large, the overhead caused by the header may be significant. Consequently, the transmission efficiency of voice packets may be low. Therefore, methods for transmitting voice packets to address this issue are needed.

### DISCLOSURE

### Technical Problem

The present disclosure is directed to providing a method and an apparatus for aggregated transmission of voice packets in a non-terrestrial network.

### Technical Solution

A method of a user equipment (UE), according to exemplary embodiments of the present disclosure for achieving the above-described objective, may comprise: receiving aggregation configuration information for a packet aggregation operation from a base station; generating a first aggregated packet including a plurality of packets based on the aggregation configuration information; and transmitting the first aggregated packet to the base station, wherein the base station is a base station located in a non-terrestrial network based on a transparent payload or a non-terrestrial network based on a regenerative payload.

The aggregation configuration information may include at least one of a packet aggregation indicator indicating whether to perform a packet aggregation operation, aggregation scheme information indicating a scheme of the packet aggregation operation, or aggregation factor information indicating a number of the plurality of packets included in the first aggregated packet.

Each of the plurality of packets may be a medium access control (MAC) protocol data unit (MPDU), the plurality of packets may be generated according to a preset periodicity, and the first aggregated packet may be a physical protocol data unit (PPDU).

The method may further comprise: receiving, from the base station, a signaling message requesting provision of information on a maximum aggregation factor supported by the UE; and transmitting information on the maximum aggregation factor to the base station, wherein the aggregation configuration information may be configured in consideration of the maximum aggregation factor.

The generating of the first aggregated packet may comprise: in response to an aggregation factor indicated by the aggregation configuration information being K, generating the first aggregated packet including K packets.

The generating of the first aggregated packet may comprise: generating a first packet including a first header and a first payload; generating a second packet including a second header and a second payload; and generating the first aggregated packet including the first header, the first payload, the second payload, and a first cyclic redundancy check (CRC) field; the first aggregated packet including the first header, the second payload, the first payload, and the first CRC field; the first aggregated packet including the second header, the first payload, the second payload, and a second CRC field; or the first aggregated packet including the second header, the second payload, the first payload, and the second CRC field.

When the information on the aggregation scheme included in the aggregation configuration information indicates an aggregation scheme 1, a number of aggregated packets including one packet may be 1, and when the information on the aggregation scheme indicates an aggregation scheme 2, a number of aggregated packets including one packet may be 2 or more.

The method may further comprise: generating a second aggregated packet including a plurality of packets based on the aggregation configuration information; and transmitting the second aggregated packet to the base station, wherein when the aggregation scheme 1 is used, a first packet may be included only in the first aggregated packet, and when the aggregation scheme 2 is used, the first packet may be included in both the first aggregated packet and the second aggregated packet.

When the aggregation scheme 1 is used, a transmission periodicity of the first aggregated packet and the second aggregated packet may be a multiple of a generation periodicity of the plurality of packets, and when the aggregation scheme 2 is used, a transmission periodicity of the first aggregated packet and the second aggregated packet may be identical to a generation periodicity of the plurality of packets.

A method of a base station, according to exemplary embodiments of the present disclosure for achieving the above-described objective, may comprise: generating aggregation configuration information for a packet aggregation operation; transmitting the aggregation configuration information to a user equipment (UE); receiving a first aggregated packet including a plurality of packets from the UE based on the aggregation configuration information; and obtaining the plurality of packets included in the first aggregated packet based on the aggregation configuration information, wherein the base station is a base station located in a non-terrestrial network based on a transparent payload or a non-terrestrial network based on a regenerative payload.

The aggregation configuration information may include at least one of a packet aggregation indicator indicating whether to perform a packet aggregation operation, aggregation scheme information indicating a scheme of the packet aggregation operation, or aggregation factor information indicating a number of the plurality of packets included in the first aggregated packet.

Each of the plurality of packets may be a medium access control (MAC) protocol data unit (MPDU), the plurality of packets may be generated according to a preset periodicity, and the first aggregated packet may be a physical protocol data unit (PPDU).

The method may further comprise: transmitting, to the UE, a signaling message requesting provision of information on a maximum aggregation factor supported by the UE; and receiving information on the maximum aggregation factor from the UE, wherein the aggregation configuration information may be configured in consideration of the maximum aggregation factor.

When an aggregation factor included in the aggregation configuration information indicates K, the first aggregated packet may include K packets, and K may be a natural number greater than or equal to 2.

When the information on the aggregation scheme included in the aggregation configuration information indicates an aggregation scheme 1, a number of aggregated packets including one packet may be 1, and when the information on the aggregation scheme indicates an aggregation scheme 2, a number of aggregated packets including one packet may be 2 or more.

A user equipment (UE), according to exemplary embodiments of the present disclosure for achieving the above-described objective, may comprise at least one processor, wherein the at least one processor causes the UE to perform: receiving aggregation configuration information for a packet aggregation operation from a base station; generating a first aggregated packet including a plurality of packets based on the aggregation configuration information; and transmitting the first aggregated packet to the base station, wherein the base station is a base station located in a non-terrestrial network based on a transparent payload or a non-terrestrial network based on a regenerative payload.

The aggregation configuration information may include at least one of a packet aggregation indicator indicating whether to perform a packet aggregation operation, aggregation scheme information indicating a scheme of the packet aggregation operation, or aggregation factor information indicating a number of the plurality of packets included in the first aggregated packet.

The at least one processor may cause the UE to perform: receiving, from the base station, a signaling message requesting provision of information on a maximum aggregation factor supported by the UE; and transmitting information on the maximum aggregation factor to the base station, wherein the aggregation configuration information may be configured in consideration of the maximum aggregation factor.

In the generating of the first aggregated packet, the at least one processor may cause the UE to perform: in response to an aggregation factor indicated by the aggregation configuration information being K, generating the first aggregated packet including K packets.

The at least one processor may cause the UE to perform: generating a second aggregated packet including a plurality of packets based on the aggregation configuration information; and transmitting the second aggregated packet to the base station, wherein when the aggregation scheme 1 is used, a first packet may be included only in the first aggregated packet, and when the aggregation scheme 2 is used, the first packet may be included in both the first aggregated packet and the second aggregated packet.

### Advantageous Effects

According to the present disclosure, in a non-terrestrial network, a base station can transmit aggregation configuration information to a terminal. Based on the aggregation configuration information, the terminal can generate a single aggregated packet that includes multiple packets and transmit the aggregated packet to the base station. Through this operation, the overhead caused by headers can be reduced, and transmission efficiency and/or transmission reliability can be improved. In other words, the performance of the non-terrestrial network can be enhanced.

### DESCRIPTION OF DRAWINGS

FIG. 1A is a conceptual diagram illustrating a first exemplary embodiment of a non-terrestrial network.

FIG. 1B is a conceptual diagram illustrating a second exemplary embodiment of a non-terrestrial network.

FIG. 2A is a conceptual diagram illustrating a third exemplary embodiment of a non-terrestrial network.

FIG. 2B is a conceptual diagram illustrating a fourth exemplary embodiment of a non-terrestrial network.

FIG. 2C is a conceptual diagram illustrating a fifth exemplary embodiment of a non-terrestrial network.

FIG. 3 is a block diagram illustrating a first exemplary embodiment of a communication node constituting a non-terrestrial network.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6A is a conceptual diagram illustrating a first exemplary embodiment of a protocol stack of a user plane in a transparent payload-based non-terrestrial network.

FIG. 6B is a conceptual diagram illustrating a first exemplary embodiment of a protocol stack of a control plane in a transparent payload-based non-terrestrial network.

FIG. 7A is a conceptual diagram illustrating a first exemplary embodiment of a protocol stack of a user plane in a regenerative payload-based non-terrestrial network.

FIG. 7B is a conceptual diagram illustrating a first exemplary embodiment of a protocol stack of a control plane in a regenerative payload-based non-terrestrial network.

FIG. 8 is a conceptual diagram illustrating a first exemplary embodiment of a packet (e.g. voice packet).

FIG. 9 is a conceptual diagram illustrating a first exemplary embodiment of an aggregated packet.

FIG. 10 is a conceptual diagram illustrating a second exemplary embodiment of an aggregated packet.

FIG. 11 is a conceptual diagram illustrating a third exemplary embodiment of an aggregated packet.

FIG. 12 is a sequence chart illustrating a first exemplary embodiment of a packet aggregation method in a non-terrestrial network.

### BEST MODE OF THE INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”

In the present disclosure, “(re)transmission” may refer to “transmission”, “retransmission”, or “transmission and retransmission”, “(re)configuration” may refer to “configuration”, “reconfiguration”, or “configuration and reconfiguration”, “(re)connection” may refer to “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted. In addition to the exemplary embodiments explicitly described in the present disclosure, operations may be performed according to a combination of the exemplary embodiments, extensions of the exemplary embodiments, and/or modifications of the exemplary embodiments. Performance of some operations may be omitted, and the order of performance of operations may be changed.

Even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g. payload-based NTN), operations of a base station may refer to operations of a satellite, and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In the present disclosure, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g. master information block (MIB), system information block (SIB)) and/or RRC messages. The MAC signaling may refer to a transmission and reception operation of a MAC control element (CE). The PHY signaling may refer to a transmission and reception operation of control information (e.g. downlink control information (DCI), uplink control information (UCI), and sidelink control information (SCI)).

In the present disclosure, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In the present disclosure, “signal and/or channel” may mean a signal, a channel, or “signal and channel,” and “signal” may be used to mean “signal and/or channel”.

A communication system may include at least one of a terrestrial network, non-terrestrial network, 4G communication network (e.g. long-term evolution (LTE) communication network), 5G communication network (e.g. new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which exemplary embodiments are applied is not limited to the content described below, and the exemplary embodiments may be applied to various communication networks (e.g. 4G communication network, 5G communication network, and/or 6G communication network). Here, a communication network may be used in the same sense as a communication system.

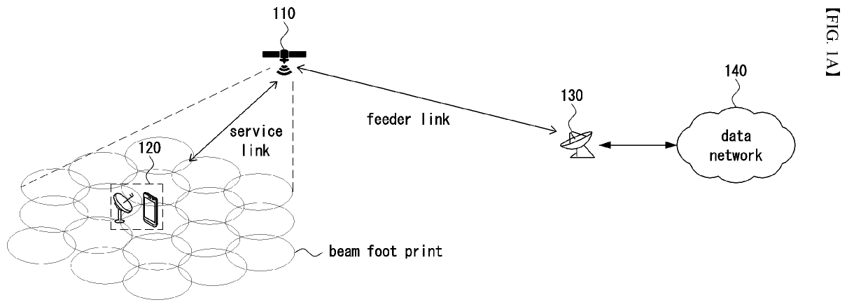

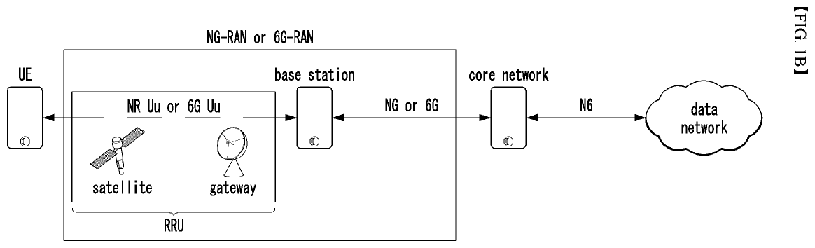

FIG. 1A is a conceptual diagram illustrating a first exemplary embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS). A non-GEO satellite may be an LEO satellite and/or MEO satellite.

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical or circular.

In the non-terrestrial network, three types of service links can be supported as follows.
Earth-fixed: a service link may be provided by beam(s) that continuously cover the same geographic area at all times (e.g. geosynchronous orbit (GSO) satellite).
quasi-earth-fixed: a service link may be provided by beam(s) covering one geographical area during a limited period and provided by beam(s) covering another geographical area during another period (e.g. non-GSO (NGSO) satellite forming steerable beams).
earth-moving: a service link may be provided by beam(s) moving over the Earth's surface (e.g. NGSO satellite forming fixed beams or non-steerable beams).

The communication node 120 may perform communications (e.g. downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g. base stations supporting 4G, 5G, and/or 6G functionality) as well as the satellite 110, and perform DC operations based on the techniques defined in 4G, 5G, and/or 6G technical specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface, a 6G-Uu interface, or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the 4G communication technology, 5G communication technology, and/or 6G communication technology. For example, the core network may include an access and mobility management function (AMF), a user plane function (UPF), a session management function (SMF), and the like. The communications between the gateway 130 and the core network may be performed based on an NG-C/U interface or 6G-C/U interface.

As shown in an exemplary embodiment of FIG. 1B, there may be a ‘core network’ between the gateway 130 and the data network 140 in a transparent payload-based NTN.

FIG. 1B is a conceptual diagram illustrating a second exemplary embodiment of a non-terrestrial network.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface, and the communications between the base station and the core network (e.g. AMF, UPF, SMF, and the like) may be performed based on an NG-C/U interface or 6G-C/U interface.

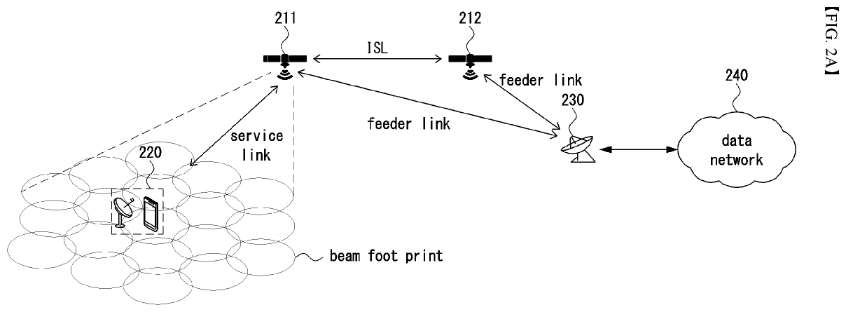

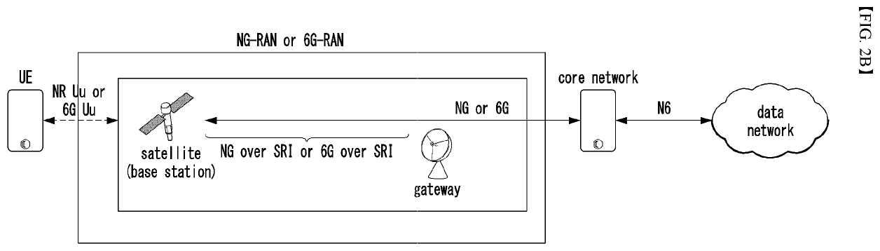

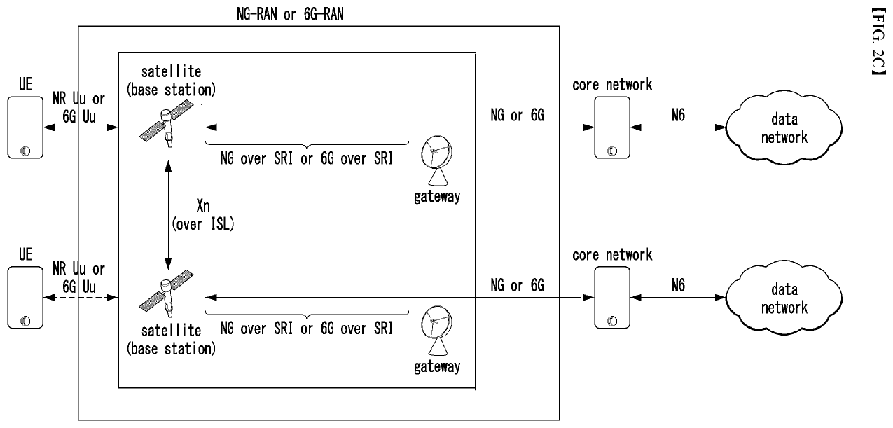

FIG. 2A is a conceptual diagram illustrating a third exemplary embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g. base stations supporting 4G, 5G, and/or 6G functionality) as well as the satellite 211, and may perform DC operations based on the techniques defined in 4G, 5G, and/or 6G technical specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

As shown in exemplary embodiments of FIG. 2B and FIG. 2C, there may be a ‘core network’ between the gateway 230 and the data network 240.

FIG. 2B is a conceptual diagram illustrating a fourth exemplary embodiment of a non-terrestrial network, and FIG. 2C is a conceptual diagram illustrating a fifth exemplary embodiment of a non-terrestrial network.

As shown in FIG. 2B and FIG. 2C, the gateway may be connected with the core network, and the core network may be connected with the data network. The core network may support the 4G communication technology, 5G communication technology, and/or 6G communication technology. For example. The core network may include AMF, UPF, SMF, and the like. Communication between the gateway and the core network may be performed based on an NG-C/U interface or 6G-C/U interface. Functions of a base station may be performed by the satellite. That is, the base station may be located on the satellite. A payload may be processed by the base station located on the satellite. Base stations located on different satellites may be connected to the same core network. One satellite may have one or more base stations. In the non-terrestrial network of FIG. 2B, an ISL between satellites may not be established, and in the non-terrestrial network of FIG. 2C, an ISL between satellites may be established.

Meanwhile, the entities (e.g. satellite, base station, UE, communication node, gateway, and the like) constituting the non-terrestrial network shown in FIGS. 1A, 1B, 2A, 2B, and/or 2C may be configured as follows. In the present disclosure, the entity may be referred to as a communication node.

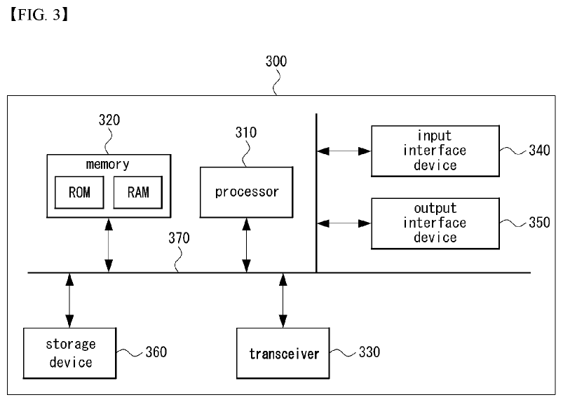

FIG. 3 is a block diagram illustrating a first exemplary embodiment of a communication node constituting a non-terrestrial network.

As shown in FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

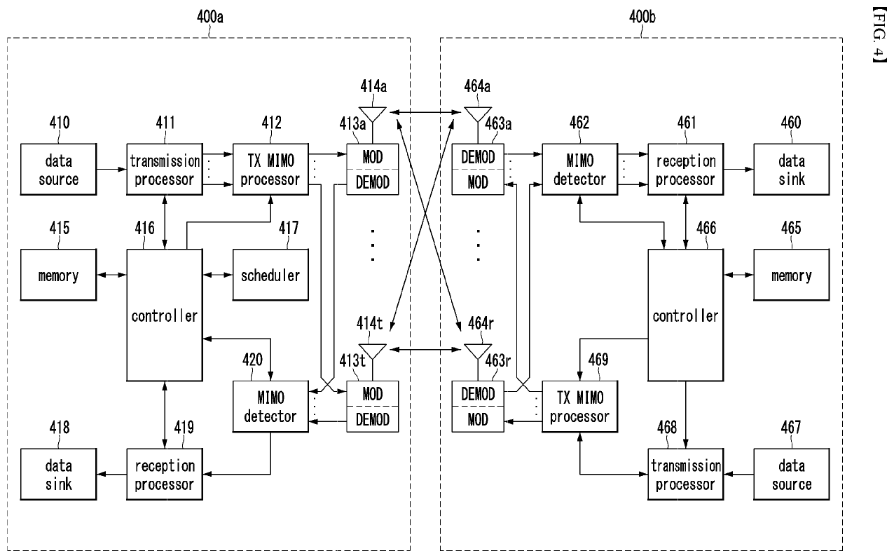

Meanwhile, communication nodes that perform communications in the communication network (e.g. non-terrestrial network) may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx

MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

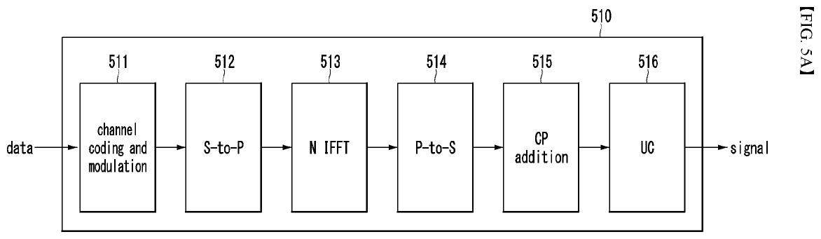

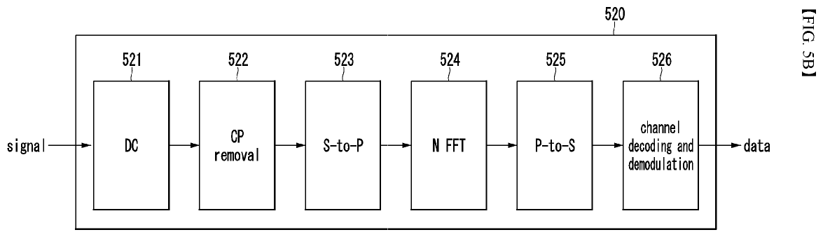

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, NTN reference scenarios may be defined as shown in Table 1 below.

TABLE 1

| | NTN shown in FIG. 1 | NTN shown in FIG. 2 |
|---|---|---|
| GEO | Scenario A | Scenario B |
| LEO (steerable beams) | Scenario C1 | Scenario D1 |
| LEO (beams moving | Scenario C2 | Scenario D2 |
| with satellite) | | |

When the satellite 110 in the NTN shown in FIG. 1A and/or FIG. 1B is a GEO satellite (e.g. a GEO satellite that supports a transparent function), this may be referred to as ‘scenario A’. When the satellites 211 and 212 in the NTN shown in FIG. 2A, FIG. 2B, and/or FIG. 2C are GEO satellites (e.g. GEOs that support a regenerative function), this may be referred to as ‘scenario B’.

When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2.’

Parameters for the NTN reference scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum (service link) | <6 GHz (e.g. 2 GHz) | |
| | >6 GHz (e.g. DL 20 GHz, UL 30 GHz) | |
| Maximum channel | 30 MHz for band <6 GHz | |
| bandwidth capability | 1 GHz for band >6 GHz | |
| (service link) | | |
| Maximum distance between | 40,581 km | 1,932 km (altitude of 600 km) |
| satellite and communication | | 3,131 km (altitude of 1,200 km) |
| node (e.g. UE) at the | | |
| minimum elevation angle | | |
| Maximum round trip delay | Scenario A: 541.46 ms | Scenario C: (transparent |
| (RTD) (only propagation | (service and feeder links) | payload: service and feeder |
| delay) | Scenario B: 270.73 ms | links) |
| | (only service link) | −5.77 ms (altitude of 60 0 km) |
| | | −41.77 ms (altitude of 1,200 km) |
| | | Scenario D: (regenerative |
| | | payload: only service link) |
| | | −12.89 ms (altitude of 600 km) |
| | | −20.89 ms (altitude of 1,200 km) |
| Maximum differential | 10.3 ms | 3.12 ms (altitude of 600 km) |
| delay within a cell | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario | Scenario | Scenario | | Scenario | |
|---|---|---|---|---|---|---|
| | A | B | C1-2 | | D1-2 | |
| Satellite altitude | 35,786 km | | 600 km | | | |
| Maximum RTD in | 541.75 ms | 270.57 ms | 28.41 | ms | 12.88 | ms |
| a radio interface | (worst case) | | | | | |
| between base | | | | | | |
| station and UE | | | | | | |
| Minimum RTD in | 477.14 ms | 238.57 ms | 8 | ms | 4 | ms |

a radio interface
between base
station and UE

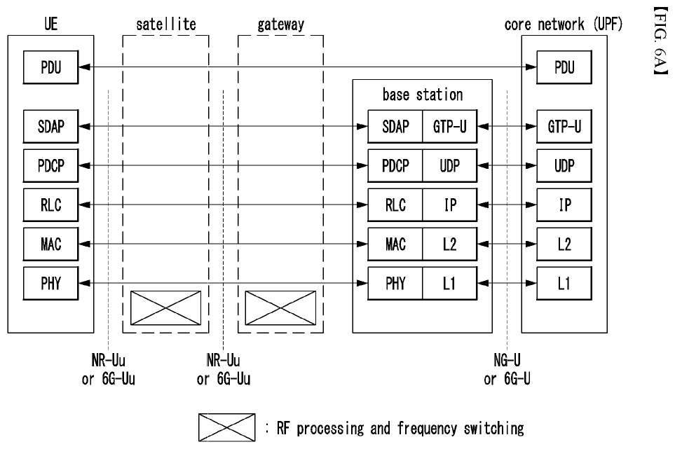

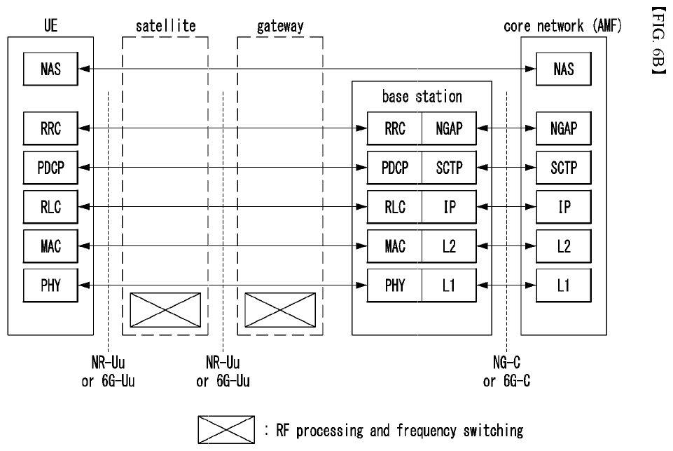

FIG. 6A is a conceptual diagram illustrating a first exemplary embodiment of a protocol stack of a user plane in a transparent payload-based non-terrestrial network, and FIG. 6B is a conceptual diagram illustrating a first exemplary embodiment of a protocol stack of a control plane in a transparent payload-based non-terrestrial network.

As shown in FIGS. 6A and 6B, user data may be transmitted and received between a UE and a core network (e.g. UPF), and control data (e.g. control information) may be transmitted and received between the UE and the core network (e.g. AMF). Each of the user data the and control data may be transmitted and received through a satellite and/or gateway. The protocol stack of the user plane shown in FIG. 6A may be applied identically or similarly to a 6G communication network. The protocol stack of the control plane shown in FIG. 6B may be applied identically or similarly to a 6G communication network.

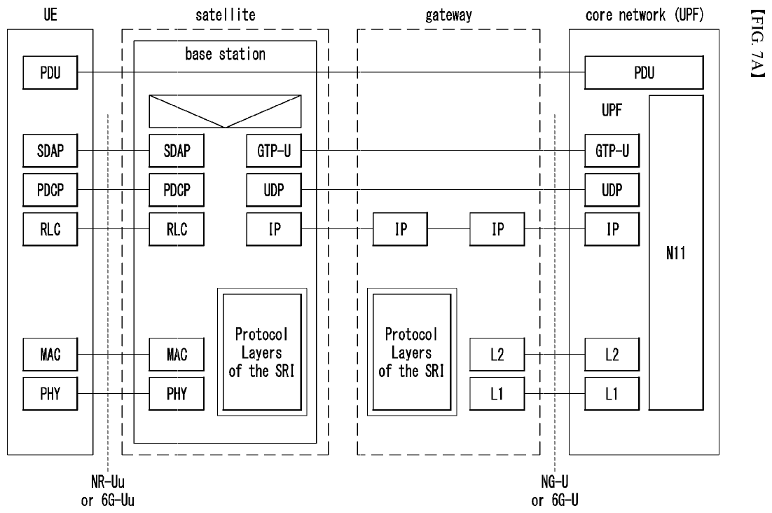

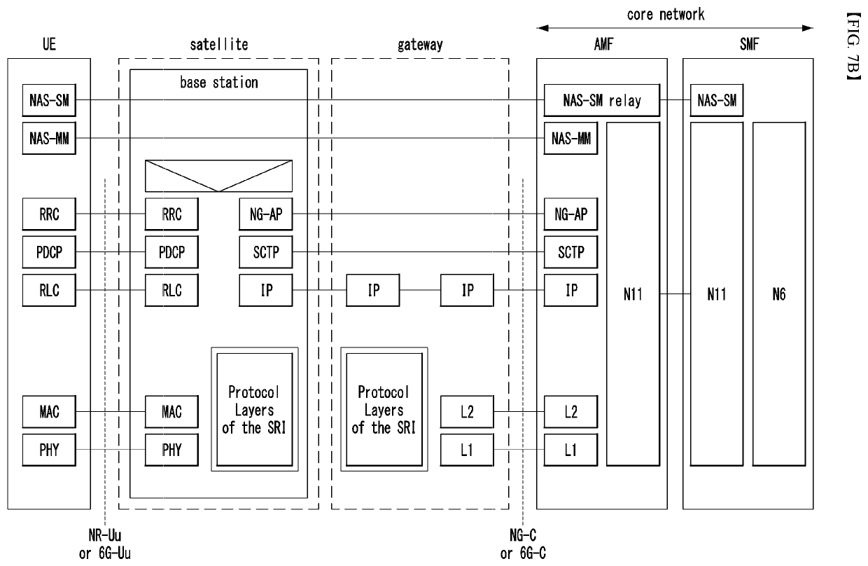

FIG. 7A is a conceptual diagram illustrating a first exemplary embodiment of a protocol stack of a user plane in a regenerative payload-based non-terrestrial network, and FIG. 7B is a conceptual diagram illustrating a first exemplary embodiment of a protocol stack of a control plane in a regenerative payload-based non-terrestrial network.

As shown in FIGS. 7A and 7B, each of user data and control data (e.g. control information) may be transmitted and received through an interface between a UE and a satellite (e.g. base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

Meanwhile, in a non-terrestrial network, a base station may transmit system information (e.g. SIB19) including satellite assistance information for NTN access. A UE may receive the system information (e.g. SIB19) from the base station, identify the satellite assistance information included in the system information, and perform communication (e.g. non-terrestrial communication) based on the satellite assistance information. The SIB19 may include information element(s) defined in Table 4 below.

TABLE 4
SIB19-r17 ::= SEQUENCE {

| | |
|---|---|
| ntn-Config-r17 | NTN-Config-r17 |
| t-Service-r17 | INTEGER(0..549755813887) |
| referenceLocation-r17 | ReferenceLocation-r17 |
| distanceThresh-r17 | INTEGER(0..65525) |
| ntn-NeighCellConfigList-r17 | NTN-NeighCellConfigList-r17 |
| lateNonCriticalExtension | OCTET STRING |

```
  ...,
  [[
```

| | |
|---|---|
| ntn-NeighCellConfigListExt-v1720 | NTN-NeighCellConfigList-r17 |

]]
}

| | |
|---|---|
| NTN-NeighCellConfigList-r17 ::= | SEQUENCE (SIZE(1..maxCellNTN-r17)) |

OF NTN-NeighCellConfig-r17

| | |
|---|---|
| NTN-NeighCellConfig-r17 ::= | SEQUENCE { |
| ntn-Config-r17 | NTN-Config-r17 |
| carrierFreq-r17 | ARFCN-ValueNR |
| physCellId-r17 | PhysCellId |

}

NTN-Config defined in Table 4 may include information element(s) defined in Table 5 below.

TABLE 5

| | |
|---|---|
| NTN-Config-r17 ::= | SEQUENCE { |
| epochTime-r17 | EpochTime-r17 |

ntn-UlSyncValidityDuration-r17 ENUMERATED{ s5, s10, s15, s20, s25, s30, s35,
s40, s45, s50, s55, s60, s120, s180, s240, s900}

| | |
|---|---|
| cellSpecificKoffset-r17 | INTEGER(1..1023) |
| kmac-r17 | INTEGER(1..512) |
| ta-Info-r17 | TA-Info-r17 |
| ntn-PolarizationDL-r17 | ENUMERATED {rhcp,lhcp,linear} |
| ntn-PolarizationUL-r17 | ENUMERATED {rhcp,lhcp,linear} |
| ephemerisInfo-r17 | EphemerisInfo-r17 |
| ta-Report-r17 | ENUMERATED {enabled} |

...
}

| | |
|---|---|
| EpochTime-r17 ::= | SEQUENCE { |
| sfn-r17 | INTEGER(0..1023), |
| subFrameNR-r17 | INTEGER(0..9) |

}

| | |
|---|---|
| TA-Info-r17 ::= | SEQUENCE { |
| ta-Common-r17 | INTEGER(0..66485757), |
| ta-CommonDrift-r17 | INTEGER(−257303..257303) |
| ta-CommonDriftVariant-r17 | INTEGER(0..28949) |

}

EphemerisInfo defined in Table 5 may include information element(s) defined in Table 6 below.

TABLE 6

| | |
|---|---|
| EphemerisInfo-r17 ::= | CHOICE { |
| positionVelocity-r17 | PositionVelocity-r17, |
| orbital-r17 | Orbital-r17 |

}

| | |
|---|---|
| PositionVelocity-r17 ::= | SEQUENCE { |
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |

}

| | |
|---|---|
| Orbital-r17 ::= | SEQUENCE { |
| semiMajorAxis-r17 | INTEGER (0..8589934591), |
| eccentricity-r17 | INTEGER (0..1048575), |
| periapsis-r17 | INTEGER (0..268435455), |
| longitude-r17 | INTEGER (0..268435455), |
| inclination-r17 | INTEGER (−67108864..67108863), |
| meanAnomaly-r17 | INTEGER (0..268435455) |

}
PositionStateVector-r17 ::= INTEGER (−33554432..33554431)
VelocityStateVector-r17 ::= INTEGER (−131072..131071)

A non-terrestrial network may support voice call services. In the non-terrestrial network, a terminal may transmit packets (e.g. voice packets) to a base station through an uplink channel (e.g. physical uplink shared channel (PUSCH)). In a transparent payload-based non-terrestrial network, the base station may be located on the ground. In this case, packets transmitted by the terminal may be delivered to the base station through a path of (terminal→satellite→gateway→base station), and packets transmitted by the base station may be delivered to the terminal through a path of (base station→gateway→satellite→terminal). In a regenerative payload-based non-terrestrial network, the base station may be located on the satellite. In this case, communication between the terminal and the base station may mean communication between the terminal and the satellite. In the present disclosure, a packet may refer to a voice packet, a video packet, or the like.

In a non-terrestrial network, very large propagation delays may occur. To satisfy the low latency requirements for voice call services in the non-terrestrial network, voice packets may be retransmitted repeatedly. Repeated retransmission of voice packets may improve transmission reliability. HARQ retransmission operations may not be applied in voice call services.

For encoding of packets (e.g. voice packets) in the non-terrestrial network, an adaptive multi-rate (AMR) codec may be used. The AMR codec may support various modes, as shown in Table 7 below. AMR_4.75 may be supported in the non-terrestrial network.

TABLE 7

| Mode | Bitrate (kbits/s) |
|---|---|
| AMR_12.20 | 12.20 |
| AMR_10.20 | 10.20 |
| AMR_7.95 | 7.95 |
| AMR_7.40 | 7.40 |
| AMR_6.70 | 6.70 |
| AMR_5.90 | 5.90 |
| AMR_5.15 | 5.15 |
| AMR_4.75 | 4.75 |
| AMR_SID | 1.80 |

When voice data (e.g. payload) is generated in the terminal, a medium access control (MAC) layer of the terminal may generate a MAC protocol data unit (MPDU) including the voice data and deliver the MPDU to a physical (PHY) layer of the terminal. The PHY layer of the terminal may receive the MPDU from the MAC layer of the terminal, generate a physical PDU (PPDU) based on the MPDU, and transmit the PPDU to the base station. The PPDU including the voice data may be a voice packet. A structure of the MPDU including voice data may be as shown in Table 8 below.

TABLE 8

| | | |
|---|---|---|
| MAC | 16 bits (w/12 bits SN) | 184 bits |
| RLC | 8 bits (w/6 bits SN) | |
| PDCP | 16 bits | |
| RTP/UDP/IP | 24 bits (w/RoHC) | |
| AMR header + | 120 bits (w/AMR payload 95 bits) | |
| AMR payload | | |

The AMR payload may be the voice data. The PPDU (e.g. voice packet) may include a PHY header, an MPDU specified in Table 8, and a cyclic redundancy check (CRC) field. The size of the CRC field (e.g. CRC bits) may be 16 bits. A generation periodicity (or transmission periodicity) of the voice packet (e.g. MPDU including voice data) may be 20 ms. Since the size of header in the voice packet is significant, the overhead caused by the header may be large. This overhead may reduce transmission efficiency, necessitating methods to address this issue.

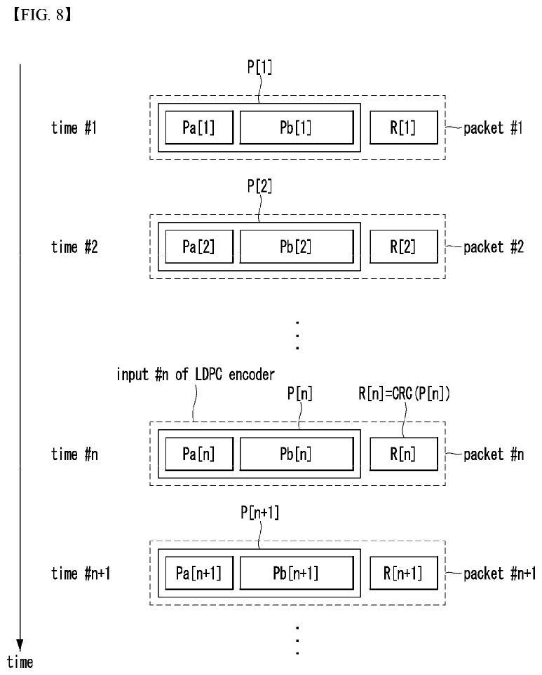

FIG. 8 is a conceptual diagram illustrating a first exemplary embodiment of a packet (e.g. voice packet).

As shown in FIG. 8, packets may be generated (or transmitted) at a predetermined interval (e.g. 20 ms). For example, a packet #1 may be generated at a time #1, a packet #2 may be generated at a time #2, a packet #n may be generated at a time #n, and a packet #n+1 may be generated at a time #n+1. In the present disclosure, each time (e.g. time #1, time #2, . . . , time #n, time #n+1, etc.) may represent a time slot. The interval between times may be 20 ms. For example, the interval between the time #1 and time #2 may be 20 ms. Each of the packets may include Pa[*], Pb[*], and R[*]. The packet may be divided into Pa[*] and Pb[*] based on a specific bit. Pa[*] may be a header, Pb[*] may be a payload, and R[*] may be a CRC field. The CRC field may be generated by the PHY layer of the terminal. R[*] (e.g. CRC field) may be a result of CRC encoding performed on data configured as a continuous bit sequence. The CRC encoding may be performed for the packet generated at a predetermined interval (e.g. 20 ms). In other words, the CRC encoding may be performed at a predetermined interval (e.g. 20 ms). R[*] may be calculated based on the entire data of the corresponding packet.

To reduce the overhead caused by packet headers (e.g. the number of bits in the packet header relative to the number of bits in the payload of the packet), the terminal may generate a single aggregated packet (e.g. single PPDU) that includes multiple packets (e.g. multiple payloads, multiple MPDUs) and transmit the aggregated packet on a PUSCH. The number K of packets (e.g. payloads, MPDUs) included in the aggregated packet may be determined by an aggregation factor K. The aggregation factor K may be a natural number. For example, if the aggregation factor is 2, a single aggregated packet including two packets may be generated. If the aggregation factor is 3, a single aggregated packet including three packets may be generated. When the aggregation factor is K, one transport block (TB) may include K packets. CRC bits of the aggregated packet may be calculated for all the packets included in the aggregated packet. The aggregation factor of each packet shown in FIG. 8 may be 1. In other words, in FIG. 8, an aggregated packet may include one packet.

When the terminal transmits a single aggregated packet including multiple packets (e.g. multiple payloads), the overhead caused by packet headers may be reduced. If a single aggregated packet including voice data is transmitted, a delay in the voice call may occur, but the requirements of voice call services in an LEO environment can be satisfied.

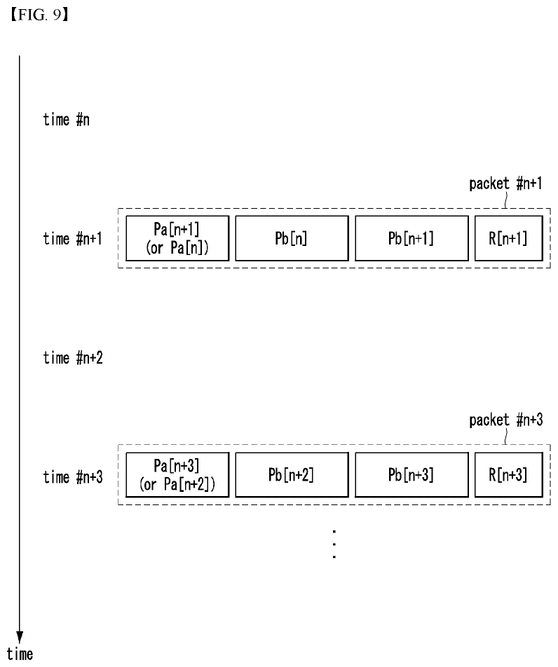

FIG. 9 is a conceptual diagram illustrating a first exemplary embodiment of an aggregated packet.

As shown in FIG. 9, when the aggregation factor is 2, the terminal may generate an aggregated packet including two packets (e.g. two consecutive packets). The terminal may generate an aggregated packet #n+1, which includes a packet #n generated at a time #n and a packet #n+1 generated at a time #n+1. An arrangement order of the packet #n and packet #n+1 within the aggregated packet #n+1 may be configured variously. The packet #n generated at the time #n may be stored in the terminal's buffer, and when the packet #n+1 is generated at the time #n+1, the terminal may generate the aggregated packet #n+1 including the packet #n and packet #n+1. n may be a natural number. The packet #n and packet #n+1 may be included in a single TB.

The packet #n may include Pa[n] and Pb[n], and the packet #n+1 may include Pa[n+1] and Pb[n+1]. The aggregated packet #n+1 may be configured as ‘Pa[n+1], Pb[n], Pb[n+1], and R[n+1]’ or ‘Pa[n+1], Pb[n+1], Pb[n], and R[n+1]’. In this case, R[n+1] may be CRC bits for Pa[n+1], Pb[n], and Pb[n+1]. In other words, R[n+1]=CRC(Pa[n+1], Pb[n], Pb[n+1]). Alternatively, the aggregated packet #n+1 may be configured as ‘Pa[n], Pb[n], Pb[n+1], and R[n+1]’ or ‘Pa[n], Pb[n+1], Pb[n], and R[n+1]’. In this case, R[n+1] may be CRC bits for Pa[n], Pb[n], and Pb[n+1]. In other words, R[n+1]=CRC(Pa[n], Pb[n], Pb[n+1]). The terminal may transmit the aggregated packet #n+1 on a PUSCH.

The terminal may generate an aggregated packet #n+3 including a packet #n+2, which is generated at a time #n+2, and a packet #n+3, which is generated at a time #n+3. An arrangement order of the packet #n+2 and packet #n+3 within the aggregated packet #n+3 may be configured variously. The packet #n+2, generated at the time #n+2, may be stored in the terminal's buffer, and when the packet #n+3 is generated at the time #n+3, the terminal may generate the aggregated packet #n+3 that includes the packet #n+2 and packet #n+3. The packet #n+2 and packet #n+3 may be included in a single TB. The packet #n+2 may include Pa[n+2] and Pb[n+2], and the packet #n+3 may include Pa[n+3] and Pb[n+3].

The aggregated packet #n+3 may be configured as ‘Pa[n+3], Pb[n+2], Pb[n+3], and R[n+3]’ or ‘Pa[n+3], Pb[n+3], Pb[n+2], and R[n+3]’. In this case, R[n+3] may be CRC bits for Pa[n+3], Pb[n+2], and Pb[n+3]. In other words, R[n+3]=CRC(Pa[n+3], Pb[n+2], Pb[n+3]). Alternatively, the aggregated packet #n+3 may be configured as ‘Pa[n+2], Pb[n+2], Pb[n+3], and R[n+3]’ or ‘Pa[n+2], Pb[n+3], Pb[n+2], and R[n+3]’. In this case, R[n+3] may be CRC bits for Pa[n+2], Pb[n+2], and Pb[n+3]. In other words, R[n+3]=CRC(Pa[n+2], Pb[n+2], Pb[n+3]). The terminal may transmit the aggregated packet #n+3 on a PUSCH.

A packet #x may be generated according to a preset periodicity (e.g. 20 ms). Pa[x] may be a header of the packet #x, and Pb[x] may be a payload of the packet #x. Since the aggregated packet #n+1, which includes the packet #n generated at the time #n and the packet #n+1 generated at the time #n+1, is transmitted at the time #n+1, transmission at the time #n may be omitted. Even if transmission is omitted at some times, all packets (e.g. all voice packets) may be transmitted without loss. Therefore, a normal voice call may be possible. Additionally, since transmissions at the time #n and the time #n+2 are omitted, these times may be used for repeated transmission of the TB. In other words, the number of repeated transmissions on the PUSCH may increase.

To perform the above-described method, the base station may transmit a signaling message to the terminal, the signaling message including at least one of a packet aggregation indicator or an aggregation factor K. The signaling message may be at least one of a system information (SI) signaling message, a radio resource control (RRC) signaling message, a medium access control (MAC) signaling message (e.g. MAC control element (CE)), or a physical layer (PHY) signaling message (e.g. DCI). The packet aggregation indicator may indicate whether the packet aggregation operation is performed. The size of the packet aggregation indicator may be 1 bit. The packet aggregation indicator set to a first value (e.g. 0) may indicate that the packet aggregation operation is not performed. The packet aggregation indicator set to a second value (e.g. 1) may indicate that the packet aggregation operation is performed.

The packet aggregation indicator may not be signaled. In this case, whether the packet aggregation operation is performed may be determined based on the aggregation factor K. For example, if the aggregation factor is indicated as 1, this may mean that the packet aggregation operation is not performed. If the aggregation factor is indicated as 2 or more, this may mean that the packet aggregation operation is performed.

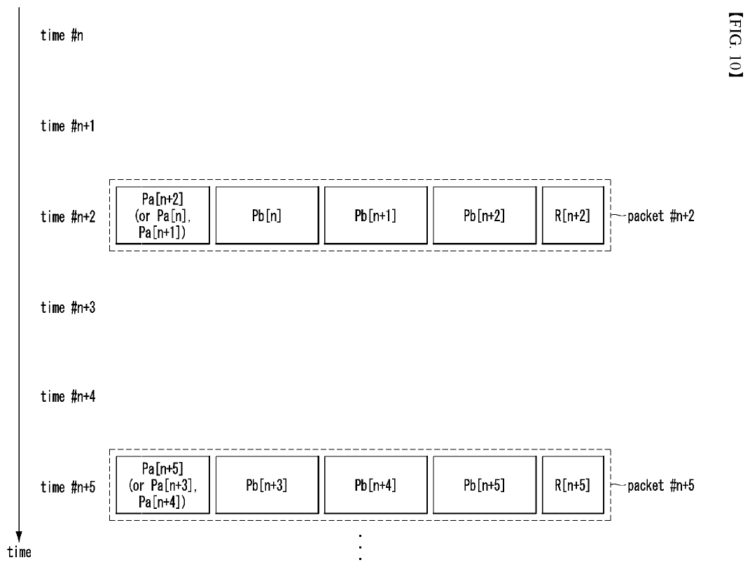

FIG. 10 is a conceptual diagram illustrating a second exemplary embodiment of an aggregated packet.

As shown in FIG. 10, when the aggregation factor is 3, the terminal may generate an aggregated packet including three packets (e.g. three consecutive packets). The terminal may generate an aggregated packet #n+2 including a packet #n, which is generated at a time #n, a packet #n+1, which is generated at a time #n+1, and a packet #n+2, which is generated at a time #n+2. An arrangement order of the packet #n, packet #n+1, and packet #n+2 within the aggregated packet #n+2 may be configured variously. The packet #n generated at the time #n and the packet #n+1 generated at the time #n+1 may be stored in the terminal's buffer, and when the packet #n+2 is generated at the time #n+2, the terminal may generate the aggregated packet #n+2 including the packet #n, packet #n+1, and packet #n+2. The packet #n, packet #n+1, and packet #n+2 may be included in a single TB.

The packet #n may include Pa[n] and Pb[n], the packet #n+1 may include Pa[n+1] and Pb[n+1], and the packet #n+2 may include Pa[n+2] and Pb[n+2]. The aggregated packet #n+2 may be configured as ‘Pa[n+2], Pb[n], Pb[n+1], Pb[n+2], and R[n+2]’ or ‘Pa[n+2], Pb[n+2], Pb[n], Pb[n+1], and R[n+2]’. In this case, R[n+2] may be CRC bits for Pa[n+2], Pb[n], Pb[n+1], and Pb[n+2]. In other words, R[n+2]=CRC(Pa[n+2], Pb[n], Pb[n+1], Pb[n+2]). Alternatively, the aggregated packet #n+2 may be configured as ‘Pa[n+1], Pb[n], Pb[n+1], Pb[n+2], and R[n+1]’. In this case, R[n+1] may be CRC bits for Pa[n+1], Pb[n], Pb[n+1], and Pb[n+2]. In other words, R[n+1]=CRC(Pa[n+1], Pb[n], Pb[n+1], Pb[n+2]). Alternatively, the aggregated packet #n+2 may be configured as ‘Pa[n], Pb[n], Pb[n+1], Pb[n+2], and R[n]’. In this case, R[n] may be CRC bits for Pa[n], Pb[n], Pb[n+1], and Pb[n+2]. In other words, R[n]=CRC(Pa[n], Pb[n], Pb[n+1], Pb[n+2]). The terminal may transmit the aggregated packet #n+2 on a PUSCH.

The terminal may generate an aggregated packet #n+5 including a packet #n+3, which is generated at a time #n+3, a packet #n+4, which is generated at a time #n+4, and a packet #n+5, which is generated at a time #n+5. An arrangement order of the packet #n+3, packet #n+4, and packet #n+5 within the aggregated packet #n+5 may be configured variously. The packet #n+3 generated at the time #n+3 and the packet #n+4 generated at the time #n+4 may be stored in the terminal's buffer, and when the packet #n+5 is generated at the time #n+5, the terminal may generate the aggregated packet #n+5 including the packet #n+3, packet #n+4, and packet #n+5. The packet #n+3, packet #n+4, and packet #n+5 may be included in a single TB.

The packet #n+3 may include Pa[n+3] and Pb[n+3], the packet #n+4 may include Pa[n+4] and Pb[n+4], and the packet #n+5 may include Pa[n+5] and Pb[n+5]. The aggregated packet #n+5 may be configured as ‘Pa[n+5], Pb[n+3], Pb[n+4], Pb[n+5], and R[n+5]’ or ‘Pa[n+5], Pb[n+5], Pb[n+3], Pb[n+4], and R[n+5]’. In this case, R[n+5] may be CRC bits for Pa[n+5], Pb[n+3], Pb[n+4], and Pb[n+5]. In other words, R[n+5]=CRC(Pa[n+5], Pb[n+3], Pb[n+4], Pb[n+5]). Alternatively, the aggregated packet #n+5 may be configured as ‘Pa[n+4], Pb[n+3], Pb[n+4], Pb[n+5], and R[n+4]’. In this case, R[n+4] may be CRC bits for Pa[n+4], Pb[n+3], Pb[n+4], and Pb[n+5]. In other words, R[n+4]=CRC(Pa[n+4], Pb[n+3], Pb[n+4], Pb[n+5]). Alternatively, the aggregated packet #n+5 may be configured as ‘Pa[n+3], Pb[n+3], Pb[n+4], Pb[n+5], and R[n+3]’. In this case, R[n+3] may be CRC bits for Pa[n+3], Pb[n+3], Pb[n+4], and Pb[n+5]. In other words, R[n+3]=CRC(Pa[n+3], Pb[n+3], Pb[n+4], Pb[n+5]). The terminal may transmit the aggregated packet #n+5 on a PUSCH.

If the aggregation factor is 3 or higher, the size of the information indicating the aggregation factor may be 2 bits or more. The information indicating the aggregation factor may indicate whether the packet aggregation operation is to be performed.

The base station may determine the aggregation factor and inform the terminal of the aggregation factor. Before this operation, the following operations may be performed. The base station may request the terminal to provide information on the maximum aggregation factor the terminal can support. This request may be included in a signaling message. The terminal may inform the base station of the maximum aggregation factor it can support in response to the request. This information may be included in a signaling message.

The base station may determine the aggregation factor within the maximum aggregation factor supported by the terminal. The base station may consider factors such as transmission latency, voice call service requirements (e.g. latency requirements), or uplink signal strength when determining the aggregation factor. The base station may transmit a signaling message to the terminal including the determined aggregation factor. The terminal may identify the aggregation factor determined by the base station, generate aggregated packets based on the identified aggregation factor, and transmit the generated aggregated packets to the base station. The signaling message used for the above-described operation may include at least one of an RRC signaling message, a MAC signaling message (e.g. MAC CE), or a PHY signaling message (e.g. DCI, UCI).

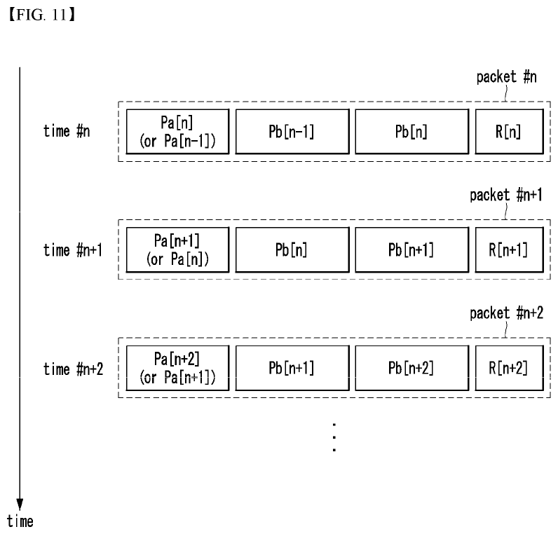

In the exemplary embodiments of FIG. 9 and FIG. 10, some headers may not be transmitted. For example, in the exemplary embodiment of FIG. 9, Pa[n] and Pa[n+1] may be assumed to be the same header, and the packet #n+1 may include Pa[n] or Pa[n+1]. Similarly, Pa[n+2] and Pa[n+3] may be assumed to be the same header, and the packet #n+3 may include Pa[n+2] or Pa[n+3]. In the exemplary embodiment of FIG. 10, Pa[n], Pa[n+1], and Pa[n+2] may be assumed to be the same header, and the packet #n+2 may include Pa[n], Pa[n+1], or Pa[n+2]. Similarly, Pa[n+3], Pa[n+4], and Pa[n+5] may be assumed to be the same header, and the packet #n+5 may include Pa[n+3], Pa[n+4], or Pa[n+5]. The communication node (e.g. base station) receiving the aggregated packet may pre-know the header included in the aggregated packet. In the exemplary embodiments of FIG. 9 and FIG. 10, the arrangement order of the payloads (e.g. Pb[*]) included in a single aggregated packet (e.g. TB) may be configured variously. For example, in the aggregated packet #n+1, Pb[n+1] may be placed before Pb[n]. The exemplary embodiments of FIG. 9 and FIG. 10 may be defined as an aggregation scheme 1, and the exemplary embodiment of FIG. 11, described later, may be defined as an aggregation scheme 2.

According to the methods described above, a single aggregated packet (e.g. TB, PPDU) that includes multiple payloads (e.g. multiple packets, multiple MPDUs) may be transmitted on a single PUSCH. Thus, the number of PUSCH repetitions may increase. If the packet aggregation operation is not used, voice packets may be transmitted within 20 ms in a non-terrestrial network supporting a 15 kHz subcarrier spacing (SCS). In this case, the maximum number of PUSCH repetitions may be 20. When the packet aggregation operation is used, and the aggregation factor is 2, voice packets may be transmitted within 40 ms. In this case, the maximum number of PUSCH repetitions may be 40. When the packet aggregation operation is used, the overhead caused by header transmission may be reduced, resource efficiency may improve, and resources allocated for the PUSCHs may decrease.

FIG. 11 is a conceptual diagram illustrating a third exemplary embodiment of an aggregated packet.

As shown in FIG. 11, when the aggregation factor is 2, the terminal may generate an aggregated packet including two packets (e.g. two consecutive packets). A single packet may be included in two aggregated packets. For example, Pb[n] generated at a time #n may be included in both an aggregated packet #n and an aggregated packet #n+1, and Pb[n+1] generated at a time #n+1 may be included in both the aggregated packet #n+1 and an aggregated packet #n+2. In other words, Pb[*] may be included in adjacent aggregated packets (e.g. adjacent TBs). In the aggregation scheme 2, the aggregated packet may be generated for each packet generation periodicity (e.g. 20 ms), whereas in the aggregation scheme 1, the generation/transmission periodicity of the aggregated packet may be a multiple of the packet generation periodicity.

The terminal may transmit the aggregated packet #n to the base station at the time #n, the aggregated packet #n+1 at the time #n+1, and the aggregated packet #n+2 at the time #n+2. Within each of the aggregated packets #n, #n+1, and #n+2, an arrangement order of packets may be configured variously. The aggregated packet #n may be configured as ‘Pa[n], Pb[n−1], Pb[n], and R[n]’, ‘Pa[n], Pb[n], Pb[n−1], and R[n]’, ‘Pa[n−1], Pb[n], Pb[n−1], and R[n−1]’, or ‘Pa[n−1], Pb[n−1], Pb[n], and R[n−1]’. The aggregated packet #n+1 may be configure as ‘Pa[n+1], Pb[n], Pb[n+1], and R[n+1]’, ‘Pa[n+1], Pb[n+1], Pb[n], and R[n+1]’, ‘Pa[n], Pb[n+1], Pb[n], and R[n]’, or ‘Pa[n], Pb[n], Pb[n+1], and R[n]’. The aggregated packet #n+2 may be configured as ‘Pa[n+2], Pb[n+1], Pb[n+2], and R[n+2]’, ‘Pa[n+2], Pb[n+2], Pb[n+1], and R[n+2]’, ‘Pa[n+1], Pb[n+2], Pb[n+1], and R[n+1]’, or ‘Pa[n+1], Pb[n+1], Pb[n+2], and R[n+1]’.

An arrangement order of payloads (e.g. Pb[*]) included in a single aggregated packet (e.g. TB) may be configured variously. For example, in the aggregated packet #n+1, Pb[n+1] may be placed before Pb[n].

In the aggregation scheme 2, an aggregation factor of 3 or more may be used. The base station may transmit a signaling message to the terminal that includes at least one of a packet aggregation indicator or an aggregation factor. The terminal may receive the signaling message from the base station and identify information element(s) included in the signaling message. The terminal may determine that a packet aggregation operation is performed and identify the aggregation factor for the operation.

According to the above-described methods, multiple payloads may be included in a single TB, and the TB may be transmitted on a single PUSCH. This may improve transmission reliability. In a non-terrestrial network supporting AMR_4.75, if a packet aggregation operation is not performed, the size of a packet including a header, a single payload, and a CRC field may be 200 bits, and the packet may be transmitted on a single PUSCH. If the aggregation scheme 2 is used in a non-terrestrial network supporting AMR_4.75, the size of a packet including a header, multiple payloads, and a CRC field may be 295 bits, and the packet may be repeatedly transmitted on two PUSCHs. When the same transmission power is used, using the aggregation scheme 2 may be advantageous in terms of transmission power per payload bit.

The aggregation scheme 1 and aggregation scheme 2 may be selectively used. The base station may transmit a signaling message (e.g. SI signaling message, RRC signaling message, MAC signaling message, and/or PHY signaling message) to the terminal that includes information on one of the aggregation schemes. The terminal may receive the signaling message from the base station, generate an aggregated packet based on the aggregation scheme indicated by the signaling message, and transmit the aggregated packet to the base station.

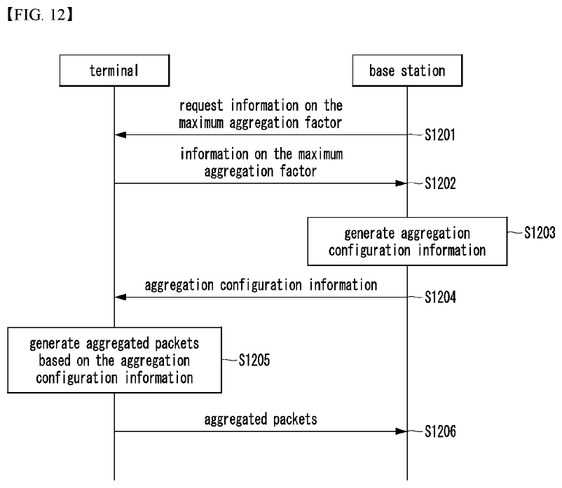

FIG. 12 is a sequence chart illustrating a first exemplary embodiment of a packet aggregation method in a non-terrestrial network.

As shown in FIG. 12, a base station may be a base station in a transparent payload-based non-terrestrial network or a base station in a regenerative payload-based non-terrestrial network. In a transparent payload-based non-terrestrial network, the base station may be located on the ground. In this case, communication between the terminal and the base station may be performed through a path of terminal-satellite-gateway-base station path. In a regenerative payload-based non-terrestrial network, the base station may be located on a satellite. In this case, communication between the terminal and the base station may refer to communication between the terminal and the satellite.

To support the packet aggregation operation, the base station may request the terminal to transmit information on the maximum aggregation factor that the terminal can support (S1201). In step S1201, the request may be transmitted through a signaling message. In the present disclosure, the signaling message may be at least one of an SI signaling message, an RRC signaling message, a MAC signaling message (e.g. MAC CE), or a PHY signaling message (e.g. DCI, UCI).

The terminal may transmit the signaling message including information on the maximum aggregation factor that the terminal can support to the base station in response to the base station's request (S1202). In step S1202, the terminal may also transmit a signaling message including information on the maximum aggregation factor that the terminal can support to the base station without a request from the base station.

The base station may determine the maximum aggregation factor supported by the terminal based on the signaling message received from the terminal. If the maximum aggregation factor supported by the terminal is 1, the base station may determine that the terminal does not support the packet aggregation operation. If the maximum aggregation factor supported by the terminal is 2 or greater, the base station may determine that the terminal supports the packet aggregation operation.

When the packet aggregation operation can be performed, the base station may determine an aggregation scheme (e.g. aggregation scheme 1 or aggregation scheme 2) and/or an aggregation factor. The aggregation scheme and/or aggregation factor may be determined by considering various information (e.g. transmission delay, requirements of voice call services, uplink signal strength, transmission power, etc.). The above-described steps S1201 and S1202 may be omitted. In this case, the base station may determine whether to perform the packet aggregation operation, the aggregation scheme, and/or the aggregation factor without considering the maximum aggregation factor supported by the terminal.

The base station may generate aggregation configuration information that includes at least one of a packet aggregation indicator, information on the aggregation scheme, or information on the aggregation factor (S1203). The packet aggregation indicator may indicate whether the packet aggregation operation is performed. The size of the packet aggregation indicator may be 1 bit. The packet aggregation indicator set to a first value (e.g. 0) may indicate that the packet aggregation operation is not performed. The packet aggregation indicator set to a second value (e.g. 1) may indicate that the packet aggregation operation is performed.

The information on the aggregation scheme may indicate the aggregation scheme 1 or aggregation scheme 2. In the aggregation scheme 1, a single packet (e.g. a single payload, a single MPDU) may be included in a single aggregated packet (e.g. a single PPDU), and a generation/transmission periodicity of the aggregated packet may be a multiple of a generation periodicity of the packet. The aggregation scheme 1 may be applied in the exemplary embodiments of FIG. 9 and/or FIG. 10. In the aggregation scheme 2, a single packet may be included in multiple aggregated packets, and a generation/transmission periodicity of the aggregated packet may be the same as a generation periodicity of the packets. The aggregation scheme 2 may be applied in the exemplary embodiment of FIG. 11. Here, the packet may be a voice packet.

The information on the aggregation factor may indicate the number of packets (e.g. payloads, MPDUs) included in a single aggregated packet. When the aggregation factor is set to 1, a single aggregated packet may include one packet. When the aggregation factor is set to 2, a single aggregated packet may include two packets. The aggregation factor set to 1 may imply that the packet aggregation operation is not performed. The aggregation factor set to 2 or more may imply that the packet aggregation operation is performed.

The base station may transmit a signaling message including the aggregation configuration information to the terminal (S1204). The terminal may receive the signaling message from the base station and identify the aggregation configuration information (e.g. the packet aggregation indicator, information on the aggregation scheme, and/or information on the aggregation factor) included in the signaling message. The terminal may determine whether to perform the packet aggregation operation based on the aggregation configuration information. If the packet aggregation operation is not performed, the terminal may transmit packets without aggregating them. If the packet aggregation operation is performed, the terminal may generate aggregated packets based on the aggregation scheme and/or the aggregation factor (S1205).

When the aggregation scheme 1 is used, the terminal may generate an aggregated packet that includes multiple packets (e.g. multiple payloads, multiple PPDUs) as shown in the exemplary embodiments of FIG. 9 and/or FIG. 10. The terminal may transmit the aggregated packet to the base station (S1206). When the aggregation scheme 1 is used, a generation/transmission periodicity of the aggregated packets may be a multiple of a generation periodicity of the packets (e.g. 20 ms).

When the aggregation scheme 2 is used, the terminal may generate an aggregated packet that includes multiple packets (e.g. multiple payloads, multiple MPDUs) as shown in the exemplary embodiment of FIG. 11. The terminal may transmit the aggregated packet to the base station (S1206). When the aggregation scheme 2 is used, a generation/transmission periodicity of the aggregated packets may be the same as a generation periodicity of the packets (e.g. 20 ms).

The base station may receive the aggregated packet from the terminal based on the aggregation configuration information (e.g. the packet aggregation indicator, information on the aggregation scheme, and/or information on the aggregation factor) and may obtain the multiple packets (e.g. multiple payloads) included in the aggregated packet.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a user equipment (UE), comprising:
receiving aggregation configuration information for a packet aggregation operation from a base station;
generating a first aggregated packet including a plurality of packets based on the aggregation configuration information; and
transmitting the first aggregated packet to the base station,
wherein the base station is a base station located in a non-terrestrial network based on a transparent payload or a non-terrestrial network based on a regenerative payload.

2. The method according to claim 1, wherein the aggregation configuration information includes at least one of a packet aggregation indicator indicating whether to perform a packet aggregation operation, aggregation scheme information indicating a scheme of the packet aggregation operation, or aggregation factor information indicating a number of the plurality of packets included in the first aggregated packet.

3. The method according to claim 1, wherein each of the plurality of packets is a medium access control (MAC) protocol data unit (MPDU), the plurality of packets are generated according to a preset periodicity, and the first aggregated packet is a physical protocol data unit (PPDU).

4. The method according to claim 1, further comprising:
receiving, from the base station, a signaling message requesting provision of information on a maximum aggregation factor supported by the UE; and
transmitting information on the maximum aggregation factor to the base station,
wherein the aggregation configuration information is configured in consideration of the maximum aggregation factor.

5. The method according to claim 1, wherein the generating of the first aggregated packet comprises: in response to an aggregation factor indicated by the aggregation configuration information being K, generating the first aggregated packet including K packets.

6. The method according to claim 1, wherein the generating of the first aggregated packet comprises:
generating a first packet including a first header and a first payload;
generating a second packet including a second header and a second payload; and
generating the first aggregated packet including the first header, the first payload, the second payload, and a first cyclic redundancy check (CRC) field; the first aggregated packet including the first header, the second payload, the first payload, and the first CRC field; the first aggregated packet including the second header, the first payload, the second payload, and a second CRC field; or the first aggregated packet including the second header, the second payload, the first payload, and the second CRC field.

7. The method according to claim 1, wherein when the information on the aggregation scheme included in the aggregation configuration information indicates an aggregation scheme 1, a number of aggregated packets including one packet is 1, and when the information on the aggregation scheme indicates an aggregation scheme 2, a number of aggregated packets including one packet is 2 or more.

8. The method according to claim 7, further comprising:
generating a second aggregated packet including a plurality of packets based on the aggregation configuration information; and
transmitting the second aggregated packet to the base station,
wherein when the aggregation scheme 1 is used, a first packet is included only in the first aggregated packet, and when the aggregation scheme 2 is used, the first packet is included in both the first aggregated packet and the second aggregated packet.

9. The method according to claim 9, wherein when the aggregation scheme 1 is used, a transmission periodicity of the first aggregated packet and the second aggregated packet is a multiple of a generation periodicity of the plurality of packets, and when the aggregation scheme 2 is used, a transmission periodicity of the first aggregated packet and the second aggregated packet is identical to a generation periodicity of the plurality of packets.

10. A method of a base station, comprising:
generating aggregation configuration information for a packet aggregation operation;
transmitting the aggregation configuration information to a user equipment (UE);
receiving a first aggregated packet including a plurality of packets from the UE based on the aggregation configuration information; and
obtaining the plurality of packets included in the first aggregated packet based on the aggregation configuration information,
wherein the base station is a base station located in a non-terrestrial network based on a transparent payload or a non-terrestrial network based on a regenerative payload.

11. The method according to claim 10, wherein the aggregation configuration information includes at least one of a packet aggregation indicator indicating whether to perform a packet aggregation operation, aggregation scheme information indicating a scheme of the packet aggregation operation, or aggregation factor information indicating a number of the plurality of packets included in the first aggregated packet.

12. The method according to claim 10, wherein each of the plurality of packets is a medium access control (MAC) protocol data unit (MPDU), the plurality of packets are generated according to a preset periodicity, and the first aggregated packet is a physical protocol data unit (PPDU).

13. The method according to claim 10, further comprising:
transmitting, to the UE, a signaling message requesting provision of information on a maximum aggregation factor supported by the UE; and
receiving information on the maximum aggregation factor from the UE,
wherein the aggregation configuration information is configured in consideration of the maximum aggregation factor.

14. The method according to claim 10, wherein when an aggregation factor included in the aggregation configuration information indicates K, the first aggregated packet includes K packets, and K is a natural number greater than or equal to 2.

15. The method according to claim 10, wherein when the information on the aggregation scheme included in the aggregation configuration information indicates an aggregation scheme 1, a number of aggregated packets including one packet is 1, and when the information on the aggregation scheme indicates an aggregation scheme 2, a number of aggregated packets including one packet is 2 or more.

16. A user equipment (UE) comprising at least one processor, wherein the at least one processor causes the UE to perform:
receiving aggregation configuration information for a packet aggregation operation from a base station;
generating a first aggregated packet including a plurality of packets based on the aggregation configuration information; and
transmitting the first aggregated packet to the base station,
wherein the base station is a base station located in a non-terrestrial network based on a transparent payload or a non-terrestrial network based on a regenerative payload.

17. The UE according to claim 16, wherein the aggregation configuration information includes at least one of a packet aggregation indicator indicating whether to perform a packet aggregation operation, aggregation scheme information indicating a scheme of the packet aggregation operation, or aggregation factor information indicating a number of the plurality of packets included in the first aggregated packet.

18. The UE according to claim 16, wherein the at least one processor causes the UE to perform:
receiving, from the base station, a signaling message requesting provision of information on a maximum aggregation factor supported by the UE; and
transmitting information on the maximum aggregation factor to the base station,
wherein the aggregation configuration information is configured in consideration of the maximum aggregation factor.

19. The UE according to claim 16, wherein in the generating of the first aggregated packet, the at least one processor causes the UE to perform: in response to an aggregation factor indicated by the aggregation configuration information being K, generating the first aggregated packet including K packets.

20. The UE according to claim 16, wherein the at least one processor causes the UE to perform:
generating a second aggregated packet including a plurality of packets based on the aggregation configuration information; and
transmitting the second aggregated packet to the base station,
wherein when the aggregation scheme 1 is used, a first packet is included only in the first aggregated packet, and when the aggregation scheme 2 is used, the first packet is included in both the first aggregated packet and the second aggregated packet.
